(19) United States
(12) Patent Application Publication
(10) Pub. No.: US 2020/0008274 A1
(43) Pub. Date: Jan. 2, 2020

(54) MICROWAVE OVEN INCLUDING FROZEN FOOD DEFROST MODE AND FOOD DRYING FUNCTION

(71) Applicant: INA, Inc., Gwangju (KR)

(72) Inventors: Hee Jong BAEK, Gwangju (KR); Seung Kwan LIM, Daejeon (KR); Kyung Jung KIM, Gwangju (KR); Jin Ho KIM, Gwangju (KR); Heung Dae KIM, Gwangju (KR); Se Won CHOI, Gwangju (KR)

(73) Assignee: INA, Inc., Gwangju (KR)

(21) Appl. No.: 16/022,890

(22) Filed: Jun. 29, 2018

(51) Int. Cl. H05B 6/64; H05B 6/66; H05B 6/68

(52) U.S. Cl. CPC H05B 6/6458; H05B 6/662; H05B 6/682; H05B 6/688; H05B 6/664

(57) ABSTRACT

A microwave oven including a frozen food defrost mode and a food drying function according to the present invention includes: a body formed with a space therein; a humidity sensor measuring a humidity value of the space; a magnetron emitting microwaves towards the space; a power transformer supplying power for operating a heater of the magnetron; a high voltage transformer providing power for operating a resonator of the magnetron; a power supply unit supplying power to the power transformer and the high voltage transformer; an output adjusting unit for selecting and adjusting so that the magnetron outputs any one of a plurality of set output levels; and a control unit controlling an output of the microwave according to the output level selected in the output adjusting unit, blocking the power supplied to the magnetron when the humidity value input from the humidity sensor remarkably increases in short time.

### BACKGROUND OF THE INVENTION

### Field of the Invention

The present invention relates generally to a microwave oven including a frozen food defrost mode and a food drying function. More particularly, the present invention relates to a microwave oven including a frozen food defrost mode and a food drying function, the microwave oven being capable of defrosting frozen food with complete and excellent quality and capable of drying food by controlling to alternately output a microwave output in a low level and a high level with an predetermined interval.

### Description of the Related Art

Generally, a method of freezing food has been widely used for a long time to store food long time. The freezing method is a method of storing food which increases a preservation time, prevents destruction of nutrients, maintains moisture, prevents deterioration of taste, and thus maintains food freshness for a long time.

As the freezing method, a method of storing food by rapid freezing to −40° C. to −60° C. is mainly used, and the food is stored in −20° C. as storage temperature in a case home freezer. High quality foods such as tuna are kept below −40° C. to maintain freshness.

Defrosting means that the food is returned to its original state that is before being frozen. Defrosting is to make foods ready for processing such as cutting, separating, etc., or in a condition that allows eating and drinking, and means a state of about −6° C. to 0° C. on the temperature basis of food.

A method of defrosting naturally by exposing food at room temperature for a long time is used as a defrosting method mainly used in general households. However, it takes long time for the heat in the air to penetrate the food surface and to be gradually transferred to the inside so as to defrost the food. In addition, since the food becomes defrosted from the surface, breeding of bacteria increases so that hygienic problems may occur, and thus there is a danger of food poisoning.

For example, when pork belly is defrosted at ordinary room temperature and cooked, bacteria easily breed in the process of defrosting, juice escapes and the taste of the meat becomes unsatisfactory. Particularly, in case of defrosting at room temperature of 25° C.-30° C. in summer, food exposed to high temperature for a long time induces the exponential growth of bacteria Staphylococcus aureus inducing vomiting, and salmonella inducing abdominal pain and diarrhea. These conditions are called food poisoning.

In addition, defrosting using water or salty water is used in restaurants. However, in the above method, there is a high possibility that content of the food flows out when the food is exposed for a long time for defrosting. In addition, bacterial growth cannot be suppressed and the food is easily exposed to contaminants depending on surrounding environment.

In addition, a conventional microwave oven is manufactured for the purpose of heating only, so that an output of the magnetron generating the microwave is not controlled, which is not suitable for defrosting frozen food.

For example, Korean Patent Publication Nos. 10-2014-0050475, 10-2014-0014436, and 10-2014-0014435 disclose a microwave oven including a calefaction function.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to provide a microwave oven including a frozen food defrost mode, the microwave oven being capable of effectively heating and defrosting foods by being configured to freely adjust an energy amount of a microwave to output from a low output level to a high output level capable of heating food.

In addition, the present invention provides a microwave oven including a food drying function, the microwave oven preventing the food being partially cooked or being spoiled by using a humidity sensor, and repeatedly operating a number of times in a high output level and in a low output level.

According to an embodiment of the present invention, a microwave oven including a frozen food defrost mode includes: a body formed with a space therein for putting in and defrosting frozen food; a humidity sensor installed in the body and measuring a humidity value of the space; a magnetron installed in the body and emitting microwaves towards the space; a power transformer supplying power for operating a heater of the magnetron; a high voltage transformer providing power for operating a resonator of the magnetron by generating a high voltage by a turn ratio of a primary coil to a secondary coil; a power supply unit supplying power to the power transformer and the high voltage transformer by being provided with external power; an output adjusting unit for selecting and adjusting so that the magnetron outputs any one of a plurality of set output levels differently set from each other; and a control unit controlling an output of the microwave emitted from the magnetron according to the output level selected in the output adjusting unit, blocking the power supplied to the magnetron when the humidity value input from the humidity sensor remarkably increases in short time.

The output adjusting unit includes: a manipulation unit for selecting an output of the magnetron from at least one of a high output level and a low output level that is set in a rage of being lower than the high output level; and a power monitoring unit monitoring, by the control unit, the power input to the primary coil from the power supply unit according to the output selected in the manipulation unit.

The power monitoring unit includes: a triac element installed in a power supply line connecting the power supply unit and the high voltage transformer for providing power to the high voltage transformer, and opening and closing the power supply line; a trigger signal generator generating, by the control unit, a trigger signal for operating the triac element; a zero cross detector detecting a zero cross point of the power input to the primary coil of the high voltage transformer and outputting the same to the control unit; and a reference pulse generator generating a reference pulse in a preset period.

When a low output level is selected through the manipulation unit and the reference pulse exceeds a number of preset times after a zero cross detection signal is received from the zero cross detector, the controller controls the trigger signal generator to generate a trigger signal so that the trigger signal is applied to the triac element.

A period of the reference pulse is set to be shorter than a half of a period of the power having a sine wave.

The manipulation unit includes: a first mode selecting unit of selecting a first defrost mode so as to operate the magnetron in a high output level for a first set time and in a low output level for a second set time after elapsing the set first time: and a second mode selecting unit of selecting a second defrost mode so as to operate the magnetron in a low output level for a third set time.

When a first defrost mode is selected through the manipulation unit, the magnetron may repeatedly output a number of times a high output level and a low output level, and when a second defrost mode is selected through the manipulation unit, the magnetron may repeatedly output a number of times a low output level and become an idle state.

In addition, the microwave oven including the frozen food defrost mode according to an embodiment of the present invention may further include a power compensation unit for maintaining the output of the magnetron to be constant regardless of changes in size of the external power applied to the power supply unit.

The power compensation unit includes: a voltage measuring unit detecting an output voltage of the secondary coil of the high voltage transformer; a rectifying unit transforming the output voltage of the secondary coil of the high voltage transformer to a DC voltage; and a compensation circuit unit for correcting and compensating the output voltage of the secondary coil of the high voltage transformer.

The control unit compares reference voltage information and voltage information measured in the voltage measuring unit, calculates a voltage difference between the reference voltage information and the measured voltage information, and transmits a control signal to the compensation circuit unit so as to compensate the output voltage of the secondary coil of the high voltage transformer by the calculated voltage difference.

When frozen food to be defrosted is put into the body and a first defrost mode is selected through the first mode selecting unit, the control unit transmit a control signal to the power monitoring unit so as to operate the magnetron according to a condition of the first defrost mode.

In addition, when frozen food to be defrosted is put into the body and a second defrost mode is selected through the first mode selecting unit, the control unit transmit a control signal to the power monitoring unit so as to operate the magnetron according to a condition of the second defrost mode.

In addition, in order to prevent frozen food being cooked or spoiled, when the humidity value input from the humidity sensor increases remarkably in short time, the control unit may transmit a control signal to the power monitoring unit so as to stop operation of the magnetron.

Further, the microwave oven including the frozen food defrost mode according to an embodiment of the present invention may further include a heater installed in the body and emitting heat towards the space.

In addition, the control unit may perform: measuring a humidity value by operating the humidity sensor when the drying menu is selected and control times of the magnetron and the heater are set; operating the magnetron and the heater according to the set control times; collecting values measured in the humidity sensor; performing an algorithm of sorting the measured values of the humidity sensor; performing an algorithm of calculating an average of the measured values of the humidity sensor; analyzing whether or not a target humidity value has been reached; if not, repeating from the collecting of the values measured in the humidity sensor; if so, setting a last drying time; and performing a drying operation for the set last time.

In the drying menu, the output level may be selected in three to eight stages according to a food type.

When the output level is selected according to the food type, ON/OFF control times of the magnetron and the heater are set

The humidity sensor measures a humidity value when the magnetron is in an OFF state during which noise is less as signal interference occurs by high frequency microwaves generated in the magnetron, and measures 30 or more samples per minute of the humidity values.

The target humidity value is set to decrease to fourth to eight stages in a stepwise manner, the operating the magnetron and the heater and the analyzing of whether or not the target humidity value has been reached is repeatedly performed by decreasing the target humidity value in a stepwise manner, the last drying operation is performed after the target humidity value decreases to a lowest stage.

The last drying operation is ended after maintaining a condition of the last stage for a predetermined time.

Preferably, in the decreasing the target humidity value in a stepwise manner, a condition of a first stage is maintained for at least 5 minutes as a humidity value remarkably increases and the decreases in the first stage.

In the decreasing the target humidity value in a stepwise manner, the target humidity value is decreased to a subsequent stage when a humidity value equal to or smaller than the corresponding target humidity value is measured at least three times.

According to an embodiment of the present invention, a microwave oven including a frozen food defrost mode enables a user to select and adjust an output level from a low output level to a high output level for defrosting frozen food, in addition to an output level for heating for cooking.

In addition, according to an embodiment of the present invention, by using a microwave oven including a defrost mode for frozen food, a situation where frozen food is cooked or spoiled during defrosting can be prevented by installing a humidity sensor, and defrosting the food while maintaining excellent quality is possible.

In addition, according to an embodiment of the present invention, by using a microwave oven including a frozen food defrost mode, an output level of a magnetron can be controlled in association with a type of frozen food, and thus defrosting of various frozen foods while maintaining the best texture and taste is possible.

In addition, according to an embodiment of the present invention, by using a microwave oven including a defrost mode for frozen food, a food drying function can be performed by alternately heating with high frequency microwaves generated in a magnetron and the radiant heat generated by a heater, and thus problem can be solved where the food is burned as the drying function proceeds.

In addition, according to an embodiment of the present invention, by using a microwave oven including a defrost mode for frozen food, a food drying function can be performed by alternately heating with high frequency microwaves generated in a magnetron and the radiant heat generated by a heater, and thus a situation where moisture is discharged from the inside to the outside of the food during the drying process can be minimized, and the dried food can be provided with excellent texture.

In addition, according to an embodiment of the present invention, by using a microwave oven including a defrost mode for frozen food, various foods can be effectively becomes dried by selecting an output level for food drying.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing a microwave oven including a frozen food defrost mode according to an embodiment of the present invention;

FIG. 2 is a view of a block diagram showing a configuration of the microwave oven including the frozen food defrost mode according to an embodiment of the present invention;

FIG. 3 is a view of a block diagram showing a configuration of a microwave oven including a frozen food defrost mode according to another embodiment of the present invention;

FIG. 4 is a view of a graph showing a state when an output is adjusted by a power monitoring unit of the microwave oven including the frozen food defrost mode according to an embodiment of the present invention;

FIG. 5 is a view of a graph showing an example of a frozen food defrost mode in the microwave oven including the frozen food defrost mode according to an embodiment of the present invention;

FIG. 6 is a view of a graph showing another example of a frozen food defrost mode in the microwave oven including the frozen food defrost mode according to an embodiment of the present invention;

FIG. 7 is a perspective view showing a microwave oven including a frozen food defrost mode according to another embodiment of the present invention;

FIG. 8 is a view of a block diagram showing the microwave oven including the frozen food defrost mode according to another embodiment of the present invention;

FIG. 9 is a view of a block diagram showing a configuration of a control unit of the microwave oven including the frozen food defrost mode according to another embodiment of the present invention;

FIG. 10 is a view of a flowchart showing the entire operations of the microwave oven including the frozen food defrost mode according to another embodiment of the present invention; and

FIG. 11 is a view of a flowchart showing a process of performing a food drying function in the microwave oven including the frozen food defrost mode according to another embodiment of the present invention.

### DETAILED DESCRIPTION OF THE INVENTION

Hereinafter, a preferred embodiment of a microwave oven including a frozen food defrost mode according to the present invention will be described in detail with reference to the drawings.

The present invention can be implemented in a variety of different ways and is not limited to the embodiments described below.

Hereinafter, features that are unnecessary for clearly describing the inventive concept are not included in the drawings. Also, throughout the specification, like reference numerals in the drawings denote like elements, and repetitive description will be omitted.

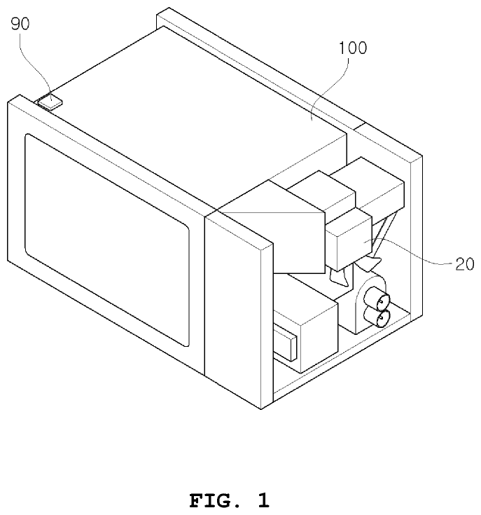

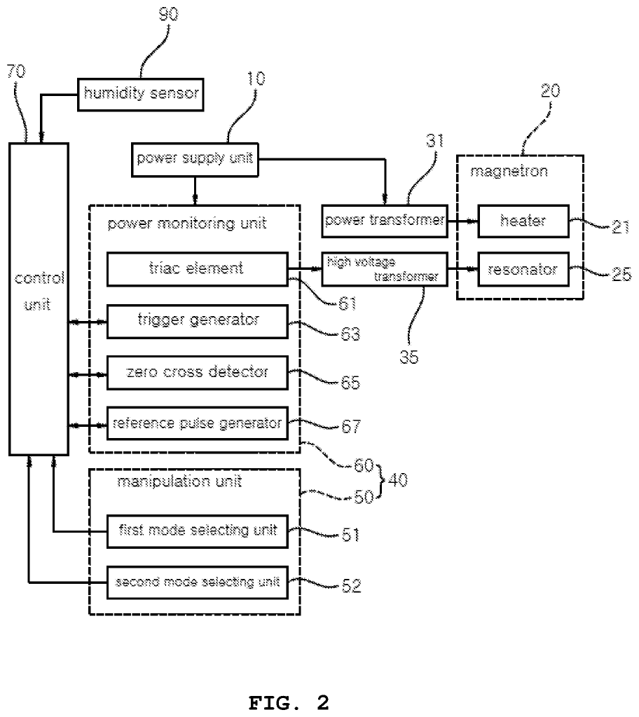

First, a microwave oven including a frozen food defrost mode according to an embodiment of the present invention includes, as shown in FIGS. 1 and 2, a body 100, a magnetron 20, a power transformer 31, a high voltage transformer 35, a power supply unit 10, an output adjusting unit 40, a control unit 70, and a humidity sensor 90.

In the body 100, a space for putting and defrosting frozen food is formed therein.

The body 100 may be formed by applying a housing or casing of a microwave oven typically used, and a manipulation unit 50 and a display unit (not shown in the figure) for displaying an operation state may be installed on an outer surface thereof.

The magnetron 20 emits microwaves for defrosting frozen food to be defrosted which is put into the space by being installed in the body 100.

The magnetron 20 is for generating microwaves, and is configured with a cylindrical anode and a cathode concentric to the anode.

The magnetron 20 includes a heater 21 for heating a cathode and a resonator 25 including a resonance circuit for resonance.

The power transformer 31 is installed to supply power for operating the heater 21 of the magnetron 20.

The high voltage transformer 35 is installed to supply power for operating the resonator 25 of the magnetron 20 by generating a high voltage through a turn ratio of a primary coil to a secondary coil.

The power supply unit 10 is installed to supply power to each of the power transformer 31, and the high voltage transformer 35 by being provided with external power.

The high voltage transformer 35 outputs a voltage that is input to the primary coil from the power supply unit 10 to the secondary coil according to the turn ratio of the primary coil to the secondary coil.

In the above, the turn ratio of the primary coil and the secondary coil of the high voltage transformer 35 means a ratio of winding turns of the primary coil to the secondary coil.

For example, when winding turns of the primary coil are N1, and winding turns of the secondary coil are N2, the turn ratio may be represented as N1/N2.

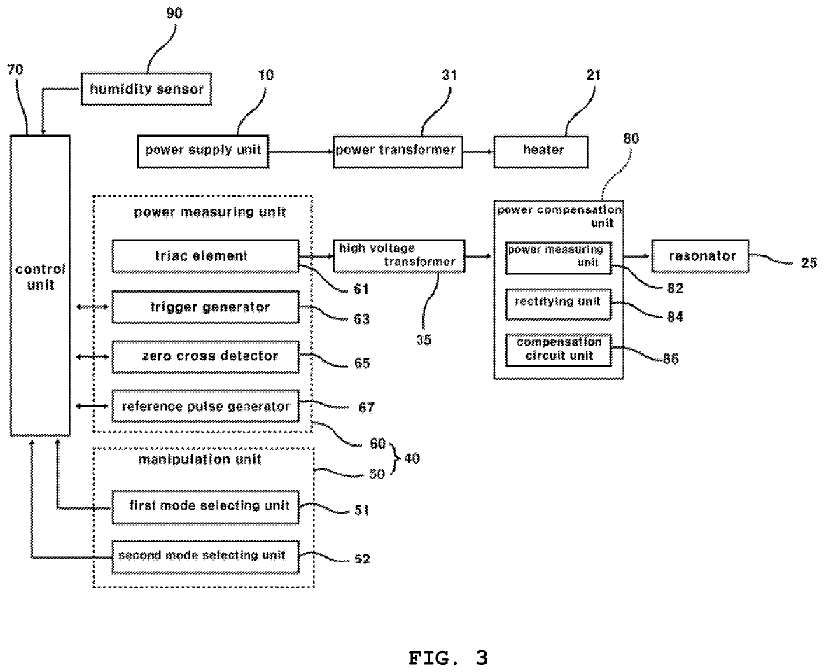

In addition, as shown in FIG. 3, in order to maintain an output of the magnetron 20 to be constant regardless of changes in sizes of external power applied to the power supply unit 10, a power compensation unit 80 may be further installed.

The power compensation unit 80 may include a voltage measuring unit 82 detecting an output voltage of the secondary coil of the high voltage transformer 35, a rectifying unit 84 transforming the output voltage of the secondary coil of the high voltage transformer 35 to a DC voltage, and a compensation circuit unit 86 for correcting and adjusting the output voltage of the secondary coil of the high voltage transformer 35.

In addition, the control unit 70 compares reference voltage information with voltage information measured in the voltage measuring unit, calculates a voltage difference between the reference information and the obtained voltage information, and controls the compensation circuit unit 86 to compensate the output voltage of the secondary coil of the high voltage transformer 35 by the calculated voltage difference.

The output adjusting unit 40 is installed to select and adjust such that the magnetron 20 outputs one of a plurality of set outputs differently set from each other.

The output adjusting unit 40 includes a manipulation unit 50 and a power monitoring unit 60.

The manipulation unit 50 is configured for selecting one of a high output level where the magnetron 20 outputs microwaves in the range of 300 W to 500 W, and a low output level where the magnetron 20 outputs microwaves in the range of 100 W to 300 W which is lower than the high output level.

In the above, the range of the low output level may be configured to be set by the operation of the power monitoring unit 60.

In addition, the manipulation unit 50 includes a first mode selection unit 51 for selecting a first defrost mode where the magnetron 20 outputs a high output level for a preset first time (for example, 30 seconds to 2 minutes) and outputs a low output level for a preset second time (for example, 3 minutes to 10 minutes) after elapsing the first time, and a second mode selection unit 52 for selecting a second defrost mode where the magnetron 20 outputs a low output level for a preset third time.

In the above, description is made by using an example where the magnetron 20 is selected to output one of a high output level and a low output level. However, the manipulation unit 50 may be configured to select at least one of a high output level, a medium output level, and a low output level.

The power monitoring unit 60 is configured such that power applied to the primary coil of the high voltage transformer 35 from the power supply unit 10 by the control unit 70 is controlled by an output level selected in the manipulation unit 50.

The power monitoring unit 60 includes a triac element 61, a trigger generator 63, a zero cross detector 65, and a reference pulse generator 67.

The triac element 61 is installed in a power supply line connecting between the power supply unit 10 and the high voltage transformer 35 to supply power to the high voltage transformer 35, and is configured to open and close the power supply line. The triac element 61 is installed to be connected to the power supply unit 10 and the high voltage transformer 35 with two terminals thereof, except for a gate terminal.

The trigger generator 63 generates a trigger signal by the control unit 70 for operating the triac element 61.

The trigger signal generated in the trigger generator 63 is input to the gate terminal of the triac element 61 and operates the triac element 61.

The zero cross detector 65 detects a zero cross point of power applied to the primary coil of the high voltage transformer 35, and outputs the same to the control unit 70.

The reference pulse generator 67 generates a reference pulse or a clock signal in a preset period set for timing.

In the above, it is preferable for a period of the reference pulse to be set shorter than a half of a period of power having a sine wave.

The control unit 70 is installed to control a microwave emitted from the magnetron 20 according to an output level selected in the output adjusting unit 40.

For example, when a low output level is selected through the manipulation unit 50 and a reference pulse exceeds a preset number of times after a zero cross detection signal transmitted from the zero cross detector 65 has been received, the control unit 70 controls to the trigger generator 63 to generate a trigger signal so that a trigger signal is applied to the triac element 61. Thus, the triac element 61 is input with a trigger signal.

Then, a process of defrosting frozen food by using a microwave oven including a frozen food defrost mode according to an embodiment of the present invention and which is configured as above will be described.

First, when a user selects a high output level by using the manipulation unit 50, a set output (rated power) is output from the high voltage transformer 35, and the above process is equal to a process of heating and cooking food by using a conventional microwave oven, and thus detailed description thereof will be omitted.

Meanwhile, when a user selects a low output level by using the manipulation unit 50, the control unit 70 checks whether or not a zero cross point of power that is input to the high voltage transformer 35 is detected in the zero cross detector 65, and if so, counts a pulse signal from a detection point, and controls the trigger generator 63 to generate a trigger signal when the counted pulse signal is equal to or greater than a preset number of times (for example, 1 or 2 times).

A trigger signal generated in the trigger generator 63 is input to the gate terminal of the triac element 61, then the triac element 61 operates, and thus power is transferred to the high voltage transformer 35.

The triac element 61 maintains a continuity state until a zero cross point (for example, potential of two terminals, except for the gate terminal, changes to 0) occurs again, and when a zero cross point occur again, the triac element 61 blocks a voltage supplied to the high voltage transformer 35.

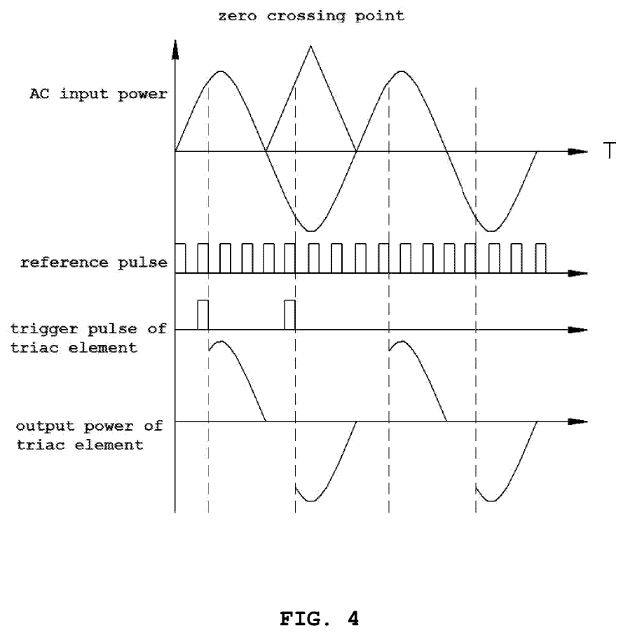

For example, as shown in FIG. 4, the triac element 61 conducts power that is input to the high voltage transformer 35 for a predetermined time, blocks the power for the rest of the time, and thus adjusts power supplied to the high voltage transformer 35. Accordingly, controlling an output generated in the magnetron 20 may be available as above.

In addition, when a user selects a first defrost mode, for example, when the user puts frozen food to be defrosted inside the body 100, and selects a first defrost mode by using the first mode selection unit 51, the control unit 70 transmits a control signal to the power monitoring unit 60 to operate the magnetron 20 according to a condition of the first defrost mode.

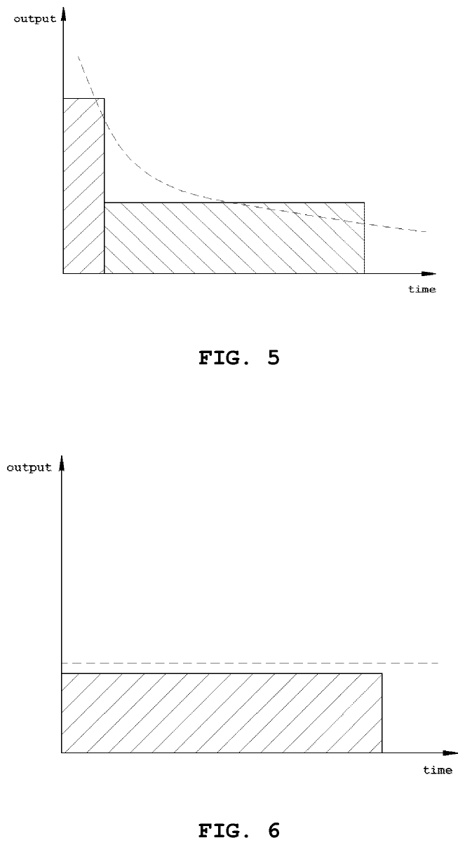

In the above, in a defrosting process of the first defrost mode, as shown in FIG. 5, as a first defrost mode is selected by the first mode selection unit 51, outputting is performed where a high output level that maintains a microwave output to be 300 W to 500 W for 30 seconds to 2 minutes so that molecules of the water which are present on a surface of the frozen food are heated by the dipole moment. By the above heat, the frozen surface of the frozen food is maximally defrosted so that more moisture may be ensured.

In addition, after the preset time (30 seconds to 2 minutes) has elapsed, outputting a lower output level that maintains a microwave output to be 100 W to 300 W for 3 minutes to 10 minutes is performed so that moisture heat of the surface generated by dipole moment is gradually transferred into the inside of the frozen food.

In the first defrost mode performed as above, a large amount of moisture is generated on a surface of the frozen food within a short time at an initial defrosting process, and then by transferring moisture heat generated afterwards, the frozen food is rapidly defrosted.

However, when overheating is induced during the operation in a high output level in performing the first defrost mode, the surface of the frozen food may become overcooked or moisture or juices thereof may be removed.

Accordingly, when a humidity value measured in the humidity sensor 90 increases by a preset value or more (for example, 10%, 20%, 30%, etc.) within a short time (for example, 3 seconds to 5 seconds, etc.), it is preferable for the control unit 70 to block power applied to the high voltage transformer 35 for a preset time (for example, 10 seconds to 30 seconds) by using the power monitoring unit 60.

By configuring as above, rapid defrosting may be performed without spoiling of the frozen food or causing degradation of the frozen food texture.

Further, the control unit 70 may be configured such that outputting a high output level and a low output level are alternately repeated a number of times in the first defrost mode.

For example, when a first defrost mode is selected, the control unit 70 may transmit a control signal to the power monitoring unit 60 to repeat outputting a number of times a high output level for 20 seconds, blocking power for 3 seconds to 5 seconds, outputting a low output level for 40 seconds, blocking power for 3 seconds to 5 seconds, outputting a high output level for 20 seconds, blocking power for 3 seconds to 5 seconds, outputting a low output level for 40 seconds, and blocking power for 3 seconds to 5 seconds.

In the above, the first defrost mode may be configured not to have time for blocking power.

In addition, when a user selects a second defrost mode, for example, when the user puts frozen food to be defrosted inside the body 100, and selects a second defrost mode through the second mode selecting unit 52, the control unit 70 transmits a control signal to the power monitoring unit 60 to operate the magnetron 20 according to a condition of the second defrost mode.

In a defrosting process of a second defrost mode configured as above, as shown in FIG. 6, as a second defrost mode is selected through the second mode selecting unit 52, outputting is performed where a low output level that maintains a microwave output of 100 W to 300 W so that moisture of the surface of the frozen food slowly generates. Accordingly, heat generated in the surface moisture is slowly transferred into the inside of the frozen food, and thus frozen food with high quality of defrosting may be provided.

In addition, the control unit 70 may be configured such that outputting a low output level and blocking power are alternately repeated a number of times in the second defrost mode.

For example, when a second defrost mode is selected, the control unit 70 may transmit a control signal to the power monitoring unit 60 to repeat outputting a number of times a low output level for 1 minutes, blocking power for 10 seconds to 20 seconds, outputting again a low output level for 1 minute, and blocking power for 10 seconds to 20 seconds.

By configuring as above, a defrosting time may be reduced at short time by selecting a first defrost mode, and defrosted food with high quality may be provided by selecting a second defrost mode even though a defrosting time takes long, or a defrost mode may be randomly selected by a user according to the need.

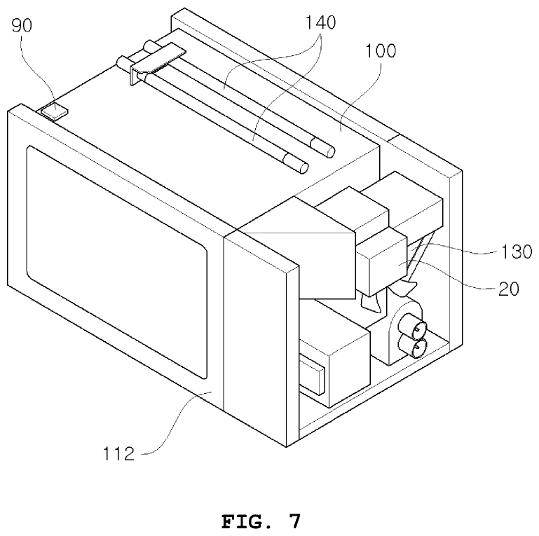

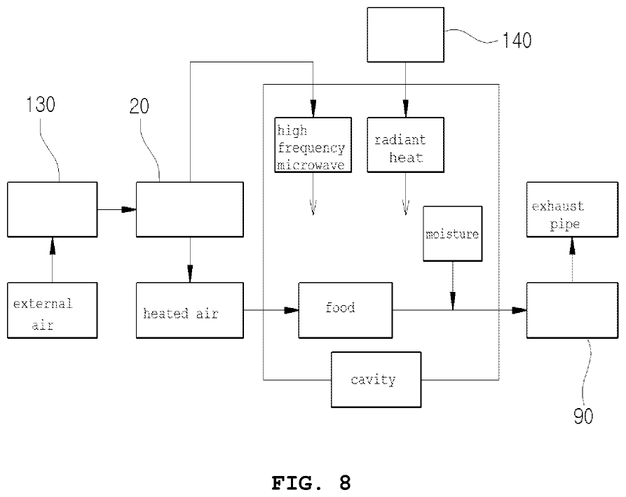

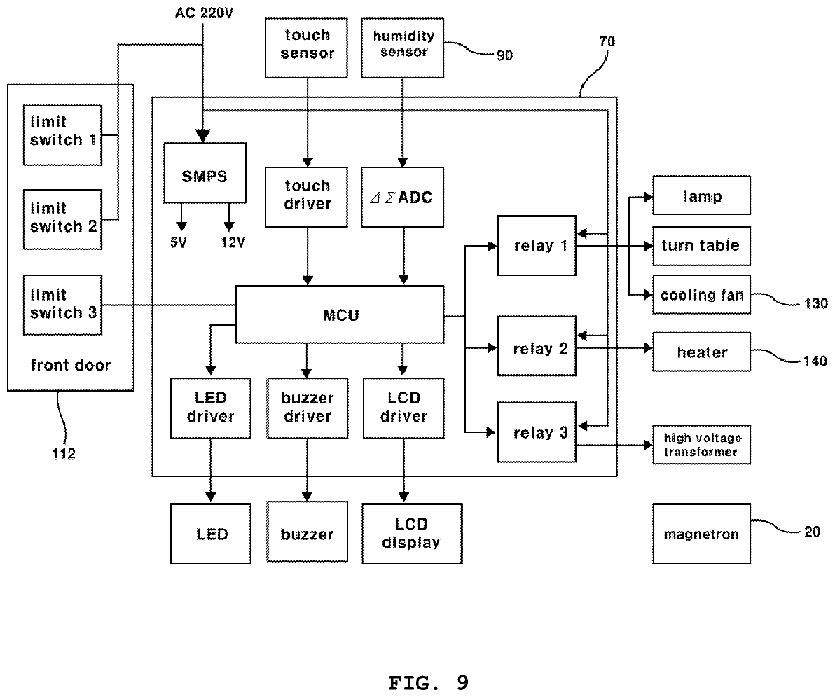

In addition, as shown in FIGS. 7 to 9, a microwave oven including a frozen food defrost mode according to another embodiment of the present invention includes: a body 100 having a space for putting or cooking a food; a humidity sensor 90 installed in an exhaust pipe that is formed inside the body 100 to air circulation, and measuring a humidity value in the air including moisture generated when food becomes dry; a magnetron 20 installed in the body 100 and radiating high frequency microwaves toward the space; a heater 140 installed in the body 100 and emitting heat to the space; a cooling fan 130 for cooling the magnetron 20 and exhausting inner air of the space of the body 100; and a control unit 70 controlling to adjust an output of the magnetron 20 and the heater 140.

In the above, power is externally supplied with AC power of 220V, the power is transformed into DC power of 12V and 5V by using SMPS, and supplied to the control unit 70 and main elements.

When the humidity sensor 90 uses an analog method, an analog-digital converter (ADC) providing a measured value that is input to the control unit 70 to the control unit 70 by converting the same to digital data may be installed in the control unit 70.

The control unit 70 is connected to an LED driver controlling LED lights outputting light according to a touch input, an LCD driver controlling an LCD display to display an operation state, and a plurality of relays performing supplying or blocking power to main elements.

In addition, in the body 100, a plurality of limit switches for detecting opening and closing of a front door 112 that is coupled to be open and closed is installed.

External air flown inside the body by the cooling fan 130, and removes heat generated by the magnetron 20 and the heated air is inwardly transferred where a food is present so that the heated air is used as a heat source.

In addition, when power is shortly applied to the magnetron 20 for food drying, heat is generated by dipole moment with a reflection of food moisture. Accordingly, moisture evaporates.

In the above, when microwaves are continuously radiated as power is continuously applied to the magnetron 20, the food may become cooked. Accordingly, it is preferable for the magnetron 20 to be controlled being applied with power for short time and having an idle state for a preset time.

An amount of moisture evaporating as the food becomes dry by microwaves of the magnetron 20 and a heat source of the heater 40 may be detected by using the humidity sensor 90 installed in the exhaust pipe.

In the above, food drying may be performed by alternately repeating ON/OFF states of the microwave generated in the magnetron 20 and a heat source generated by the heater 140 for a preset time.

Then, an operation process of the control unit 70 of the microwave oven including the frozen food defrost mode according to another embodiment and which is configured as above will be described.

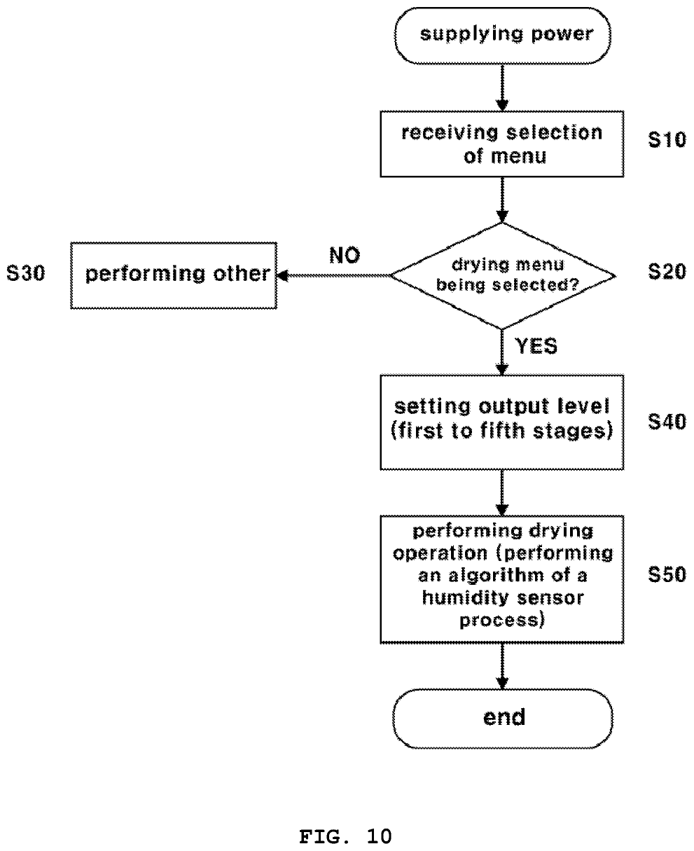

For example, as shown in FIG. 10, the control unit 70 performs, when power is supplied, step S10 of receiving a selection of a menu, step S20 of analyzing whether or not a drying menu is selected, if not, step S30 of performing another menu, and if so, step S40 of selecting an output level, and step S50 of performing a drying operation.

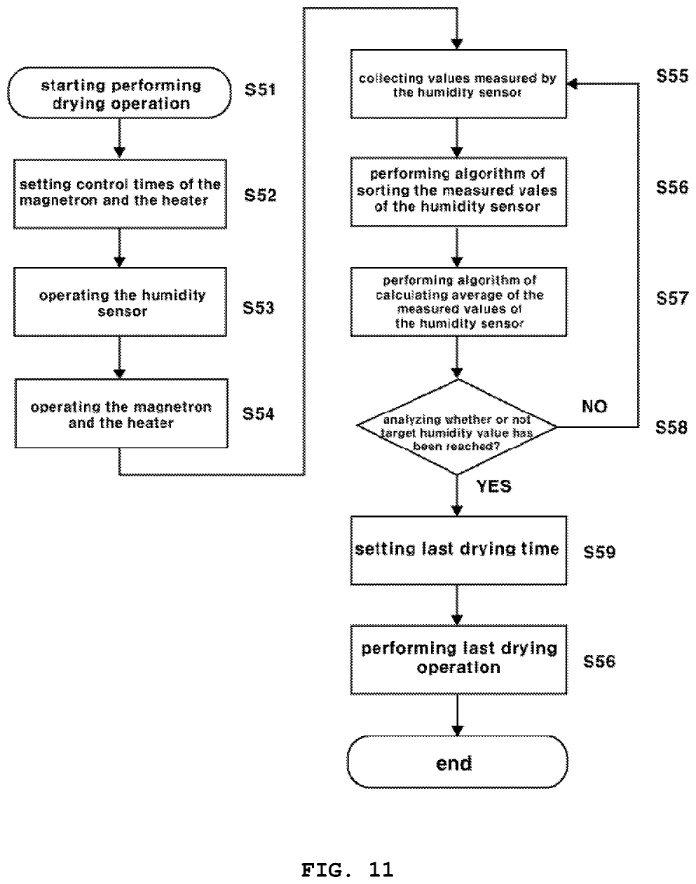

In addition, as shown in FIG. 11, as the drying menu is selected, the control unit 70 configures the step S50 of performing a drying operation to include: step S51 of starting performing a drying operation; step S52 of setting control times of the magnetron 20 and the heater 140; step S53 of operating the humidity sensor 90; step S54 of operating the magnetron 20 and the heater 140; step S55 of collecting values measured by the humidity sensor 90; step S56 of performing an algorithm of sorting the measured vales of the humidity sensor 90; step S57 of performing an algorithm of calculating an average of the measured values of the humidity sensor 90; step S58 of analyzing whether or not a target humidity value has been reached; step S59 of setting a last drying time; and step S60 of performing a last drying operation.

In step S52 of setting the control times of the magnetron 20 and the heater 140, the control times are set according to the set in step S40 of setting the output level.

For example, in step S40 of setting the output level, an output level may be selected according to a food type, and is selected from third to eighth stages.

In the above, when the output level is selected according to the food type, ON/OFF control times of the magnetron 20 and the heater 140 are set.

For example, as shown in Tables 1 to 5 below, an output level may be configured with five stages according to a food type.

For example, a condition of a first stage of the output level shown in Table 1 is suitable for foods which are very weak in heat such as radishes, carrots and zucchini, a condition of a second stage of the output level shown in Table 2 for foods which are weak in heat such as mushrooms, sage, kiwi, sweet persimmon, etc., a condition of a third stage of the output level shown in Table 3 is suitable for foods having medium-strength such as tangerine, orange, apple, a condition of a fourth stage of the output level shown in Table 4 are suitable for foods that are heat resistant such as potatoes, lotus root, etc., and a condition of a fifth stage of the output level shown in Table 5 for foods that are very strong of heat such as squid, beef jerky, sweet potatoes, etc.

TABLE 1

| | | Magnetron | | Heater | |
|---|---|---|---|---|---|
| Section | Humidity | ON | OFF | ON | OFF |
| First | 40% or | 5 | 21 | 10 | 21 |
| stage | more | | | | |
| Second | 33% or | 4 | 21 | 9 | 21 |
| level | more | | | | |
| Third | 29% or | 3 | 22 | 8 | 22 |
| stage | more | | | | |
| Fourth | 24% or | x | 11 | 7 | 11 |
| stage | more | | | | |
| Fifth | 18% or | x | 8 | 5 | 8 |
| stage | more | | | | |

| | | |
|---|---|---|
| Last | Less | A condition of the fifth stage is |
| stage | than | maintained for 1 hour and 30 minutes |
| | 18% | then automatically finished. |

TABLE 2

| | | Magnetron | | Heater | |
|---|---|---|---|---|---|
| Section | Humidity | ON | OFF | ON | OFF |
| First | 40% or | 7 | 19 | 10 | 19 |
| stage | more | | | | |
| Second | 33% or | 6 | 19 | 9 | 19 |
| stage | more | | | | |
| Third | 29% or | 5 | 20 | 8 | 20 |
| stage | more | | | | |
| Fourth | 24% or | 4 | 21 | 7 | 21 |
| stage | more | | | | |
| Fifth | 16% or | x | 10 | 5 | 10 |
| stage | more | | | | |

| | | |
|---|---|---|
| Last | Less than | A condition of the fifth stage is maintained |
| stage | 16 | for 40 minutes and then automatically finished. |

TABLE 3

| | | Magnetron | | Heater | |
|---|---|---|---|---|---|
| Section | Humidity | ON | OFF | ON | OFF |
| First | 40% or | 7 | 19 | 10 | 17 |
| stage | more | | | | |
| Second | 33% or | 6 | 19 | 9 | 17 |
| stage | more | | | | |
| Third | 29% or | 5 | 20 | 8 | 18 |
| stage | more | | | | |
| Fourth | 24% or | 4 | 21 | 7 | 19 |
| stage | more | | | | |
| Fifth | 16% or | x | 10 | 5 | 10 |
| stage | more | | | | |

| | | |
|---|---|---|
| Last | Less than | A condition of the fifth stage is maintained |
| stage | 16% | for 40 minutes and then automatically finished. |

TABLE 4

| | | Magnetron | | Heater | |
|---|---|---|---|---|---|
| Section | Humidity | ON | OFF | ON | OFF |
| First | 40% or | 7 | 19 | 10 | 15 |
| stage | more | | | | |
| Second | 33% or | 6 | 19 | 9 | 15 |
| stage | more | | | | |
| Third | 29% or | 5 | 20 | 8 | 16 |
| stage | more | | | | |
| Fourth | 24% or | 4 | 21 | 7 | 17 |
| stage | more | | | | |
| Fifth | 16% or | x | 10 | 5 | 10 |
| stage | more | | | | |

| | | |
|---|---|---|
| Last | Less than | A condition of the fifth stage is maintained |
| stage | 16% | for 40 minutes and then automatically finished. |

TABLE 5

| | | Magnetron | | Heater | |
|---|---|---|---|---|---|
| Section | Humidity | ON | OFF | ON | OFF |
| First | 40% or | 7 | 19 | 10 | 13 |
| stage | more | | | | |
| Second | 33% or | 6 | 19 | 9 | 13 |
| stage | more | | | | |
| Third | 29% or | 5 | 20 | 8 | 14 |
| stage | more | | | | |
| Fourth | 24% or | 4 | 21 | 7 | 15 |
| stage | more | | | | |
| Fifth | 16% or | x | 10 | 5 | 10 |
| stage | more | | | | |

| | | |
|---|---|---|
| Last | Less than | A condition of the fifth stage is maintained |
| stage | 16% | for 40 minutes and then automatically finished. |

In step S54 of operating the magnetron 20 and the heater 140, the control unit 70 controls the magnetron 20 and the heater 140 to be in ON/OFF states according to the control times set in response to stages of an output level which are set in step S40 of setting the output level.

In step S53 of operating the humidity sensor 90, a humidity value of the air discharging to an exhaust pipe of the body 100 is measured.

It is preferable for the humidity sensor 90 to measure a humidity value when the magnetron 20 is in an OFF state during which noise is less as signal interference occurs due to high frequency microwaves generated in the magnetron 20.

The humidity sensor 90 measures 30 or more samples of a humidity value per minute. For example, the humidity sensor 90 may measure 50 samples per minute.

In step S55 of collecting the values measured in the humidity sensor 90, the measured values collected by using the humidity sensor 90 are transformed to digital data by the ADC and then transferred to the control unit 70.

In step S56 of the performing the algorithm of sorting the measured values of the humidity sensor, the measured values of the humidity sensor 90 are sorted, and in step of the performing the algorithm of calculating the average of the measured values of the humidity sensor 90, the average of the measured values of the humidity sensor 90 is calculated and provided to as a humidity value used for comparing a target humidity value of the output level.

In step S58 of analyzing whether or not the target humidity value has been reached, whether or not the average of the measuring values of the humidity sensor 90 has been reached the target humidity value is analyzed.

In the above, when the average of the measured values of the humidity sensor 90 has not been reached the target humidity value, step S55 of collecting the values measured in the humidity sensor is performed.

In the above, the target humidity value may be set to decrease to fourth to eight stages in a stepwise manner.

For example, the target humidity value may be set as a fifth stage and a last stage as shown in Tables 1 to 5.

By configuring as above, from step S54 of operating the magnetron 20 and the heater 140 to step S58 of analyzing whether or not the target humidity value has been reached are repeatedly performed by decreasing the target humidity value in a stepwise manner, and after performing the above step for the target humidity value being the lowest stage (fifth stage of Tables 1 to 5), a last drying operation is performed.

In step S58 of analyzing whether or not the target humidity value has been reached, when the average of the measuring values of the humidity sensor 90 has reached the target humidity value, step S59 of the setting of the last drying time is performed.

For example, in step S59 of the setting of the last drying time, a condition of the last stage may be set as Tables 1 to 5.

In step S60 of performing the last drying operation, the last drying operation is performed for the last drying time that is set in the last stage as Tables 1 to 5.

In the above, the last drying operation is configured to maintain a condition of the last stage (fifth stage of Tables 1 to 5) for a predetermined time (for example, 1 hour 30 minutes or 40 minutes), and then the performing of the last drying operation is finished.

In the above, when decreasing the target humidity value in a stepwise manner, it is preferable to maintain a first stage (first stage in Tables 1 to 5) for 5 minutes since a humidity measuring value remarkable increases and then decreases.

The decreasing of the target humidity value in a stepwise manner may be configured to decrease to the following stage when a humidity value being equal to or smaller than the target humidity value has been measured at least three times.

For example, in Tables 1 to 5, when a case where an average of humidity values measured in a first stage is smaller than 40% occurs five times, it is preferable to decrease the target humidity value to a second stage which is 33% or more.

In the above, for foods that are very weak in heat as set as in Table 1, different to other output levels, the magnetron 20 may not operate from a fourth stage and the heater 140 may only operate.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A microwave oven including a frozen food defrost mode and a food drying function, the microwave oven comprising:
a body formed with a space therein for putting in and defrosting frozen food;
a humidity sensor installed in the body and measuring a humidity value of the space;
a magnetron installed in the body and emitting microwaves towards the space;
a power transformer supplying power for operating a heater of the magnetron;
a high voltage transformer providing power for operating a resonator of the magnetron by generating a high voltage by a turn ratio of a primary coil to a secondary coil;
a power supply unit supplying power to the power transformer and the high voltage transformer by being provided with external power;
an output adjusting unit for selecting and adjusting so that the magnetron outputs any one of a plurality of set output levels differently set from each other; and
a control unit controlling an output of the microwave emitted from the magnetron according to the output level selected in the output adjusting unit, blocking the power supplied to the magnetron when the humidity value input from the humidity sensor remarkably increases in short time, wherein
the output adjusting unit includes: a manipulation unit for selecting an output of the magnetron from at least one of a high output level and a low output level that is set in a rage of being lower than the high output level; and a power monitoring unit monitoring, by the control unit, the power input to the primary coil from the power supply unit according to the output selected in the manipulation unit, wherein
the power monitoring unit includes: a triac element installed in a power supply line connecting the power supply unit and the high voltage transformer for providing power to the high voltage transformer, and opening and closing the power supply line; a trigger signal generator generating, by the control unit, a trigger signal for operating the triac element; a zero cross detector detecting a zero cross point of the power input to the primary coil of the high voltage transformer and outputting the same to the control unit; and a reference pulse generator generating a reference pulse in a preset period, and
when a low output level is selected through the manipulation unit and the reference pulse exceeds a number of preset times after a zero cross detection signal is received from the zero cross detector, the controller controls the trigger signal generator to generate a trigger signal so that the trigger signal is applied to the triac element, and a period of the reference pulse is set to be shorter than a half of a period of the power having a sine wave.

2. The microwave oven of claim 1, wherein the manipulation unit includes: a first mode selecting unit of selecting a first defrost mode so as to operate the magnetron in a high output level for a first set time and in a low output level for a second set time after elapsing the set first time: and a second mode selecting unit of selecting a second defrost mode so as to operate the magnetron in a low output level for a third set time, when a first defrost mode is selected through the manipulation unit, the magnetron repeatedly outputs a number of times a high output level and a low output level, and when a second defrost mode is selected through the manipulation unit, the magnetron repeatedly outputs a number of times a low output level and becomes an OFF state.

3. The microwave oven of claim 1, further comprising a power compensation unit for maintaining the output of the magnetron to be constant regardless of changes in size of the external power applied to the power supply unit, wherein
the power compensation unit includes: a voltage measuring unit detecting an output voltage of the secondary coil of the high voltage transformer; a rectifying unit transforming the output voltage of the secondary coil of the high voltage transformer to a DC voltage; and a compensation circuit unit for correcting and compensating the output voltage of the secondary coil of the high voltage transformer, and
the control unit compares reference voltage information and voltage information measured in the voltage measuring unit, calculates a voltage difference between the reference voltage information and the measured voltage information, and transmits a control signal to the compensation circuit unit so as to compensate the output voltage of the secondary coil of the high voltage transformer by the calculated voltage difference.

4. The microwave oven of claim 1, further comprising a heater installed in the body and emitting heat towards the space, and wherein when power is supplied to the microwave oven, the control unit performs: receiving a selection of a menu; analyzing whether or not a drying menu is selected; if not, performing other menu; and if so, setting an output level, and performing a drying operation, wherein
the performing of the drying operation includes: measuring a humidity value by operating the humidity sensor when the drying menu is selected and control times of the magnetron and the heater are set; operating the magnetron and the heater according to the set control times; collecting values measured in the humidity sensor; performing an algorithm of sorting the measured values of the humidity sensor; performing an algorithm of calculating an average of the measured values of the humidity sensor; analyzing whether or not a target humidity value has been reached; if not, repeating from the collecting of the values measured in the humidity sensor; if so, setting a last drying time; and performing a drying operation for the set last time, wherein
in the drying menu, the output level is selected in three to eight stages according to a food type, and when the output level is selected according to the food type, ON/OFF control times of the magnetron and the heater are set, and
the humidity sensor measures a humidity value when the magnetron is in an OFF state during which noise is less as signal interference occurs by high frequency microwaves generated in the magnetron, and measures 30 or more samples per minute of the humidity values.

5. The microwave oven of claim 4, wherein the target humidity value is set to decrease to fourth to eight stages in a stepwise manner, the operating the magnetron and the heater and the analyzing of whether or not the target humidity value has been reached is repeatedly performed by decreasing the target humidity value in a stepwise manner, the last drying operation is performed after the target humidity value decreases to a lowest stage, and the last drying operation is ended after maintaining a condition of the last stage for a predetermined time.

6. The microwave oven of claim 5, wherein the decreasing the target humidity value in a stepwise manner includes: maintaining a condition of a first stage for at least 5 minutes as a humidity value remarkably increases and the decreases in the first stage; and decreasing the target humidity value to a subsequent stage when a humidity value equal to or smaller than the corresponding target humidity value is measured at least three times.
